(19) United States
(12) Patent Application Publication
(10) Pub. No.: US 2015/0005135 A1
(43) Pub. Date: Jan. 1, 2015

(54) TRANSMISSION SYSTEM FOR A VEHICLE

(71) Applicant: DTI Group B.V., Eindhoven (NL)

(72) Inventors: Marie Roell Van Druten, Eindhoven (NL); Alexander Franciscus Anita Serrarens, Waalre (NL); Bas Gerard Vroemen, Eindhoven (NL)

(21) Appl. No.: 14/486,958

(22) Filed: Sep. 15, 2014

Related U.S. Application Data
(62) Division of application No. 13/590,562, filed on Aug. 21, 2012.
Application No. 13/590,562 is a continuation of application No. PCT/NL2011/050135, filed on Feb. 24, 2011.

(30) Foreign Application Priority Data
Feb. 24, 2010 (NL) 2004296

(51) Int. Cl. F16H 37/02; B60W 10/107; B60W 10/04

(52) U.S. Cl. CPC F16H 37/021; B60W 10/04; B60W 10/107; F16H 2702/00
USPC 477/37

(57) ABSTRACT

A transmission system for a vehicle has a first transmission module with at least one speed transforming gear and at least one coupling. The system may further include a second transmission module with at least one speed transforming gear and at least one coupling, wherein an input shaft of the first transmission module is connected to a drive source and an output shaft of the second transmission module iss connected to an end drive. An electromotor may be coupled to the first transmission module and/or the second transmission module, via a mount point. The first transmission module and the second transmission module may be arranged in series with an output shaft of the first transmission module being connected to an input shaft of the second transmission module.

### CROSS-REFERENCE TO RELATED APPLICATIONS

This application for a utility patent is a divisional of a previously filed utility patent Ser. No. 13/590,562, filed Aug. 21, 2012, which is a continuation of a previously filed utility patent, now abandoned, having the application number PCT/NL2011/050135, filed Feb. 24, 2011 (Publication No.: WO2011/105905).

### BACKGROUND OF THE INVENTION

1. Field of the Invention

The invention relates to a transmission system for a vehicle comprising a first and a second transmission module which each comprise at least one speed transforming gear and at least one coupling and/or a continuously variable transmission with a controllable variable speed transforming gear, where an input shaft of the first transmission module can be coupled to an end drive which is connected to wheels of the vehicle, which transmission system further includes an electromotor which is coupled to one or both transmission modules.

2. Description of Related Art

A transmission system of this general type is known; however, in the known transmission system, the transmission modules are arranged in parallel with each other between the input and the output of the transmission system.

### SUMMARY OF THE INVENTION

The present invention relates to a transmission system having a first transmission module with at least one speed transforming gear and at least one coupling, and/or a continuously variable transmission with a controllable variable speed transforming gear. A second transmission module may also be included with at least one speed transforming gear and at least one coupling, wherein an input shaft of the first transmission module is connected to a drive source and an output shaft of the second transmission module iss connected to an end drive. An electromotor may be coupled to the first transmission module and/or the second transmission module, via a mount point, wherein the first transmission module and the second transmission module are arranged in series with an output shaft of the first transmission module being connected to an input shaft of the second transmission module.

### BRIEF DESCRIPTION OF THE DRAWINGS

The invention will be described below in more detail based on examples of embodiment of the transmission system according to the invention represented in the drawing figures, in which:

FIG. 1 gives a diagrammatic representation of a transmission system according to the invention;

FIG. 2 shows a constructive layout of the transmission system represented in FIG. 1;

FIG. 3 shows another constructive layout of the transmission system represented in FIG. 1, illustrating an end drive and a reduction gear set sharing a common gear; and

FIG. 4 gives a diagrammatic representation of the layout represented in FIG. 3.

### DETAILED DESCRIPTION OF THE INVENTION

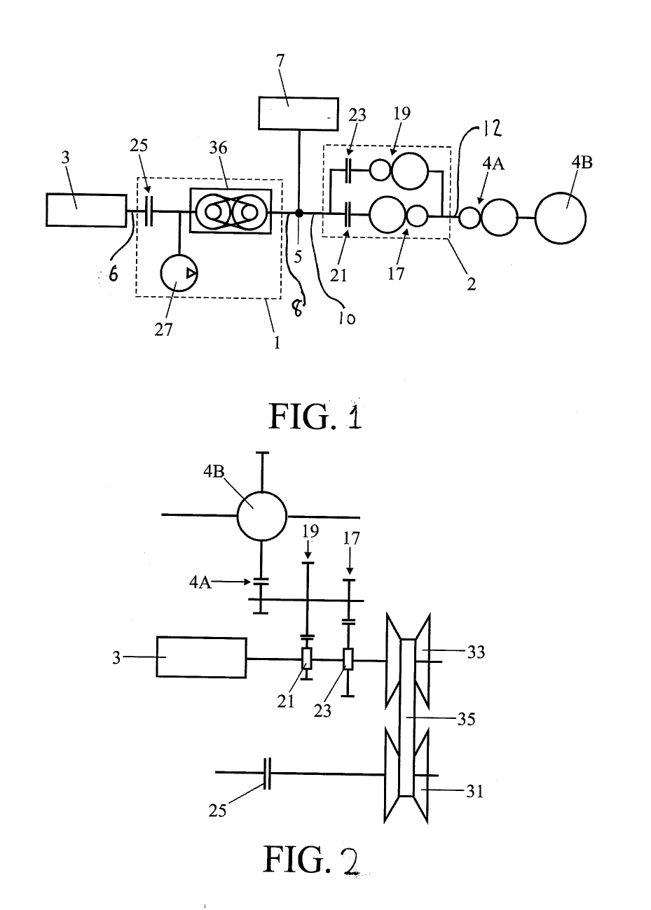

FIG. 1 gives a diagrammatic representation of a transmission system according to the invention. FIG. 2 shows a constructive layout of the transmission system represented in FIG. 1. In this embodiment, there may be a first transmission module 1, a second transmission module 2, and an electromotor 7. The first transmission module 1 may have at least one coupling 25 and a continuously variable transmission 36. The second transmission module 2 may have at least one speed transforming gear 17 and at least one coupling 21.

An input shaft 6 of the first transmission module 1 can be coupled to a drive source 3. An output shaft 12 of the second transmission module 2 may be coupled to an end drive 4a which may then be connected to wheels (not shown) of the vehicle and/or to a differential 4b. The electromotor 7 may be coupled to the first transmission module 1 or to the second transmission module 2.

Also, the first transmission module 1 and the second transmission module 2 may be arranged in series with the output shaft 8 of the first transmission module 1 being connected to the input shaft 10 of the second transmission module 2. The electromotor 7 may be connected, via a mount point 5, to the output shaft 8 of the first transmission module 1 and/or the input shaft 10 of the second transmission module 2.

The first transmission module 1 and/or the second transmission module 2 may have two (or more) switchable controllable speed transforming gears by means of which various forward gears can be realized. FIG. 1 illustrates the second transmission module 2 with a first speed transforming gear being a reduction gear set 17 and the first coupling being a clutch 21. FIG. 1 also illustrates a second speed transforming gear being a reduction gear set 19 and a second coupling being a clutch 23. The clutches 21, 23 allow gear trains to be selected, where the gear trains may be made up of the controllable variable speed transforming gear 36, the reduction gear set 17 or the reduction gear set 19, and the end drive 4a. There may also be additional speed transforming gears and clutches to increase the number of gears available. Additionally, there may be an oil pump 27 for regulating the continuously variable transmission 36.

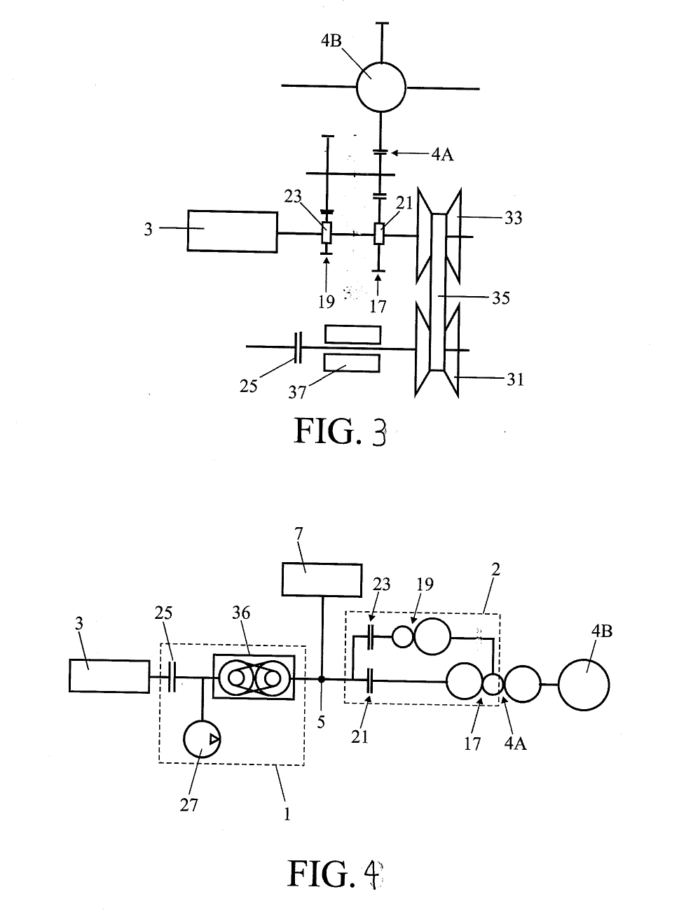

FIG. 3 shows the transmission system represented in FIG. 1, illustrating the end drive 4a and the reduction gear set 17 sharing a common gear. FIG. 4 gives a diagrammatic representation of the layout represented in FIG. 3. As seen in FIGS. 3-4, the reduction gear set 17 of the second transmission module 2 may be combined with the end drive 4a so that one less gear wheel may be used.

1. A transmission system for a vehicle, the transmission system comprising:
a first transmission module comprising at least one coupling and a controllable variable speed transforming gear;
a second transmission module comprising at least one speed transforming gear and at least one coupling, wherein an input shaft of the first transmission module is connected to a drive source and an output shaft of the second transmission module is connected to an end drive;
an electromotor which is coupled to the first transmission module and/or the second transmission module, via a mount point, wherein the first transmission module and the second transmission module are arranged in series with an output shaft of the first transmission module being connected to an input shaft of the second transmission module.

2. A transmission system as claimed in claim 1, wherein the at least one speed transforming gear is a reduction gear set.

3. A transmission system as claimed in claim 1, wherein the first transmission module and/or the second transmission module comprises two switchable controllable speed transforming gears by means of which various forward gears can be realized.

4. A transmission system as claimed in claim 3, wherein the two switchable controllable speed transforming gears are formed by two gear trains which can be selected by means of clutches.

5. A transmission system as claimed in claim 1, wherein the end drive is connected to a differential.

6. A transmission system as claimed in claim 1, the first transmission module further comprising an oil pump.

7. A vehicle comprising:
a drive source;
an end drive;
driven wheels which are connected to the end drive; and
a drive line through which the end drive is connected to the drive source, wherein the drive line comprises a transmission system comprising:
a first transmission module comprising at least one speed transforming gear and at least one coupling and/or a continuously variable transmission with a controllable variable speed transforming gear;
a second transmission module comprising at least one speed transforming gear and at least one coupling, wherein an input shaft of the first transmission module is connected to a drive source and an output shaft of the second transmission module is connected to the end drive; and
an electromotor which is coupled to the first transmission module and/or the second transmission module, via a mount point, wherein the first transmission module and the second transmission module are arranged in series with an output shaft of the first transmission module being connected to an input shaft of the second transmission module; wherein the input shaft of the first transmission module is connected to the drive source and the output shaft of the second transmission module is connected to the end drive and where the end drive is only connected to the rear wheels of the vehicle.
